(19) United States
(12) Patent Application Publication
(10) Pub. No.: US 2024/0266609 A1
(43) Pub. Date: Aug. 8, 2024

(54) BATTERY AND METHOD FOR MANUFACTURING THE SAME

(71) Applicant: Panasonic Intellectual Property Management Co., Ltd., Osaka (JP)

(72) Inventors: Shohei KUSUMOTO, Osaka (JP); Masayoshi UEMATSU, Osaka (JP)

(21) Appl. No.: 18/623,701

(22) Filed: Apr. 1, 2024

Related U.S. Application Data
(63) Continuation of application No. PCT/JP2022/031818, filed on Aug. 24, 2022.

(30) Foreign Application Priority Data
Oct. 13, 2021 (JP) 2021-168429

(51) Int. Cl. H01M 10/0585; H01M 50/172; H01M 50/533; H01M 50/534

(52) U.S. Cl. CPC H01M 10/0585; H01M 50/172; H01M 50/533; H01M 50/534

(57) ABSTRACT

A battery includes: a housing; a first power generating element; a second power generating element; and an electron conductive layer located between the first power generating element and the second power generating element, wherein the first power generating element and the second power generating element are each a stack including an electrode layer, a counter electrode layer, and a solid electrolyte layer located between the electrode layer and the counter electrode layer, the first power generating element, the second power generating element, and the electron conductive layer are stacked within the housing, and a side surface of at least one of the first power generating element or the second power generating element is in contact with an inner surface of the housing.

### CROSS REFERENCE TO RELATED APPLICATIONS

This is a continuation application of PCT International Application No. PCT/JP2022/031818 filed on Aug. 24, 2022, designating the United States of America, which is based on and claims priority of Japanese Patent Application No. 2021-168429 filed on Oct. 13, 2021. The entire disclosures of the above-identified applications, including the specifications, drawings and claims are incorporated herein by reference in their entirety.

### FIELD

The present disclosure relates to a battery and a method for manufacturing the battery.

### BACKGROUND

Conventionally, a battery is known in which a solid electrolyte layer, an electrode layer, and a current collecting member are stacked inside an electrically insulating frame (for example, see Patent Literature (PTL) 1).

### CITATION LIST

### Patent Literature

PTL 1: Japanese Unexamined Patent Application Publication No. 2011-159635

### SUMMARY

### Technical Problem

In the background art, it is desired to realize a battery with high energy density.

### Solution to Problem

A battery according to one aspect of the present disclosure includes: a housing; a first power generating element; a second power generating element; and an electron conductive layer located between the first power generating element and the second power generating element, wherein the first power generating element and the second power generating element are each a stack including an electrode layer, a counter electrode layer, and a solid electrolyte layer located between the electrode layer and the counter electrode layer, the first power generating element, the second power generating element, and the electron conductive layer are stacked within the housing, and a side surface of at least one of the first power generating element or the second power generating element is in contact with an inner surface of the housing.

A method for manufacturing a battery according to one aspect of the present disclosure is a method for manufacturing a battery including a first power generating element and a second power generating element, each of which is a stack including an electrode layer, a counter electrode layer, and a solid electrolyte layer located between the electrode layer and the counter electrode layer, the method including: putting a material for forming the first power generating element, a material for forming an electron conductive layer, and a material for forming the second power generating element into a housing in stated order; and pressing each material put into the housing.

### Advantageous Effects

According to the present disclosure, a battery with high energy density can be realized.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a cross-sectional view of a battery according to an embodiment.

FIG. 2 is a diagram for explaining a method for manufacturing a battery according to the embodiment.

FIG. 3 is a diagram for explaining the method for manufacturing the battery according to the embodiment.

FIG. 4 is a diagram for explaining the method for manufacturing the battery according to the embodiment.

FIG. 5 is a diagram for explaining the method for manufacturing the battery according to the embodiment.

FIG. 6 is a diagram for explaining a variation of the method for manufacturing the battery according to the embodiment.

FIG. 7 is a scanning electron microscope image of a cut surface of an electron conductive layer using metal foil.

FIG. 8 is a scanning electron microscope image of a cut surface of an electron conductive layer using powder.

### DESCRIPTION OF EMBODIMENTS

### Outline of the Present Disclosure

Hereinafter, a plurality of examples of batteries according to the present disclosure will be shown.

<1>

A battery including:
a housing;
a first power generating element;
a second power generating element; and
an electron conductive layer located between the first power generating element and the second power generating element,
wherein the first power generating element and the second power generating element are each a stack including an electrode layer, a counter electrode layer, and a solid electrolyte layer located between the electrode layer and the counter electrode layer,
the first power generating element, the second power generating element, and the electron conductive layer are stacked within the housing, and
a side surface of at least one of the first power generating element or the second power generating element is in contact with an inner surface of the housing.

In this way, since a side surface of at least one of the first power generating element or the second power generating element is in contact with an inner surface of the housing, the inside of the housing can be filled with the power generating elements, and the space inside the housing can be utilized effectively. For example, the space inside the housing can be utilized to the maximum. Therefore, a battery with high energy density can be realized. In addition, by including two power generating elements, the first power generating element and the second power generating element, a battery with a high voltage can be realized when the power generating elements are connected in series, and a battery with a large capacity can be realized when the power generating elements are connected in parallel.

<2>

The battery according to <1>,
wherein the electron conductive layer includes an electron conductive material, and
the electron conductive material is powder.

Accordingly, the powder of the electron conductive material spreads between the first power generating element and the second power generating element within the housing, and the electron conductive layer can be brought into close contact with the inner surface of the housing. For that reason, contact between the first power generating element and the second power generating element is suppressed, and a battery with higher energy density can be realized.

<3>

The battery according to <2>,
wherein the electron conductive layer consists only of the electron conductive material.

Accordingly, the electron conductive layer does not contain any material that inhibits electron conduction, and stable battery characteristics can be obtained. Therefore, a battery with higher energy density can be realized.

<4>

The battery according to <2> or <3>,
wherein the electron conductive layer has a grain boundary of the powder of the electron conductive material.

Accordingly, the electron conductive layer is formed with grain boundaries remaining, so the electron conductive material spreads more easily between the first power generating element and the second power generating element within the housing, and the electron conductive layer can be brought into close contact with the inner surface of the housing. Therefore, a battery with higher energy density can be realized.

<5>

The battery according to any one of <1> to <4>,
wherein the first power generating element and the second power generating element are electrically connected in series.

Accordingly, the electron conductive layer prevents the first power generating element and the second power generating element connected in series from coming into contact with each other, and prevents the short circuit (specifically, the ion conductive short circuit) between the first power generating element and the second power generating element, making it possible to achieve a higher voltage battery.

<6>

The battery according to any one of <1> to <5>,
wherein at least one of the electrode layer, the counter electrode layer, or the solid electrolyte layer in at least one of the first power generating element or the second power generating element does not contain a binder.
   <7>

The battery according to <6>,
wherein at least one of the first power generating element or the second power generating element does not contain the binder.

Since the binder is a material that does not contribute to the charge/discharge reaction, by not including the binder, it is possible to increase the proportion of the material that contributes to the charge/discharge reaction within the battery. Therefore, a battery with higher energy density can be realized.

<8>

The battery according to any one of <1> to <7>,
wherein the electron conductive layer has a thickness of at least 15 μm and at most 300 μm.

By setting the thickness of the electron conductive layer to at least 15 μm, contact between the first power generating element and the second power generating element is suppressed, and a battery with higher energy density can be realized. In addition, by setting the thickness of the electron conductive layer to at most 300 μm, the volume occupied by the electron conductive layer within the housing can be reduced, and a battery with higher energy density can be realized.

<9>

The battery according to any one of <1> to <8>,
wherein the electron conductive layer includes a void.

Accordingly, the stress corresponding to the electron conductive layer can be relaxed by the void, so damage to the electron conductive layer can be suppressed. Therefore, contact between the first power generating element and the second power generating element due to damage to the electron conductive layer is suppressed, and a battery with higher energy density can be realized.

<10>

The battery according to any one of <1> to <9>,
wherein the housing includes an insulator in contact with the side surface and a conductor electrically connected to the first power generating element.

Accordingly, the housing can be used to extract current while ensuring the insulation state on the side surfaces of the first power generating element and the second power generating element. For that reason, it is possible to miniaturize the battery without providing a lead or the like for extracting current, so a battery with higher energy density can be realized.

<11>

The battery according to <10>, further including:
a current collector disposed within the housing and on a side of the second power generating element opposite a side on which the electron conductive layer is disposed,
wherein the conductor is a bottom plate portion of the housing that faces the electron conductive layer with the first power generating element interposed between the bottom plate portion and the electron conductive layer, and
the housing includes an opening that exposes the current collector.

Accordingly, it is possible to realize a battery having a configuration in which current can be easily extracted from both sides in the stacking direction of the stack of the first power generating element, the electron conductive layer, and the second power generating element.

<12>

The battery according to any one of <1> to <11>,
wherein each of the first power generating element, the second power generating element, and the electron conductive layer is in contact with the inner surface.

This allows the space inside the housing to be utilized to the maximum, making it possible to realize a battery with higher energy density.

In addition, a plurality of examples of the method for manufacturing the battery according to the present disclosure will be shown below.

<13>

A method for manufacturing a battery including a first power generating element and a second power generating element, each of which is a stack including an electrode layer, a counter electrode layer, and a solid electrolyte layer located between the electrode layer and the counter electrode layer, the method including:
putting a material for forming the first power generating element, a material for forming an electron conductive layer, and a material for forming the second power generating element into a housing in stated order; and
pressing each material put into the housing.

In this way, by pressing each material put into the housing, the housing can be filled with the first power generating element, the second power generating element, and the electron conductive layer, making it possible to effectively utilize the space inside the housing. For example, the space inside the housing can be utilized to the maximum. Therefore, a battery with high energy density can be manufactured. In addition, by forming two power generating elements, the first power generating element and the second power generating element, a battery with a high voltage can be manufactured when the power generating elements are connected in series, and a battery with a capacity can be manufactured when the power generating elements are connected in parallel.

<14>

The method for manufacturing the battery according to <13>,
wherein the putting includes putting a material for forming the electron conductive layer in powder form into the housing.

In this way, by putting the electron conductive material in powder form into the housing and pressing it, the electron conductive material is spread out within the housing, and the electron conductive layer that separates the first power generating element and the second power generating element can be formed. For that reason, contact between the first power generating element and the second power generating element is suppressed, and a battery with higher energy density can be manufactured.

<15>

The method for manufacturing the battery according to <13> or <14>,
wherein the putting includes a material for forming the first power generating element in powder form and a material for forming the second power generating element in powder form into the housing.

Accordingly, the material in powder form can be pressed to fill the inside of the housing with the first power generating element and the second power generating element, and the space inside the housing can be effectively utilized. Therefore, a battery with higher energy density can be manufactured.

<16>

The method for manufacturing the battery according to <13> or <14>,
wherein the putting includes a material for forming the first power generating element in pellet form and a material for forming the second power generating element in pellet form into the housing.

Accordingly, the battery can be manufactured using a simpler manufacturing process.

Hereinafter, embodiments will be specifically described with reference to the drawings.

It should be noted that each of the embodiments described below shows comprehensive or specific examples. The numerical values, shapes, materials, components, arrangement positions and connection forms of the components, steps, order of steps, and the like shown in the following embodiments are examples, and are not intended to limit the present disclosure. In addition, among the components in the following embodiments, the components not described in the independent claims are described as arbitrary components.

In addition, each figure is a schematic view and is not necessarily exactly illustrated. Therefore, for example, the scales and the like in each figure do not necessarily match. In addition, in each figure, substantially the same configurations are denoted by the same reference numerals, and redundant explanations will be omitted or simplified.

In addition, in this specification, terms indicating relationships between elements such as parallel or orthogonal, terms indicating the shape of elements such as rectangle or rectangular parallelepiped, and numerical ranges are not expressions that express only strict meanings, but expressions meaning a substantially equivalent range, for example, meaning that they include a difference of about several percent.

In addition, in this specification, the “stacking direction” corresponds to the normal direction of the main surface of each layer. In addition, in this specification, “plan view” refers to a view when viewed in a direction perpendicular to the main surface of the power generating element, unless otherwise specified, such as when used alone.

In addition, in this specification, the terms “above” and “below” do not refer to the upper direction (vertically upward) and the lower direction (vertically downward) in absolute spatial recognition, but are used as terms defined by the relative positional relationship based on the stacking order in the stacked configuration. In addition, the terms “above” and “below” apply not only when two components are spaced from each other and there is another component between the two components, but also when two components are placed in close contact with each other and the two components are in contact with each other.

In addition, in this specification, ordinal numbers such as “first” and “second” do not mean the number or order of components, unless otherwise specified, but are used to avoid confusion of components of the same type and to distinguish components.

### Embodiment

Hereinafter, a battery according to an embodiment will be described.

### [Configuration]

First, the configuration of battery 1 according to the present embodiment will be described.

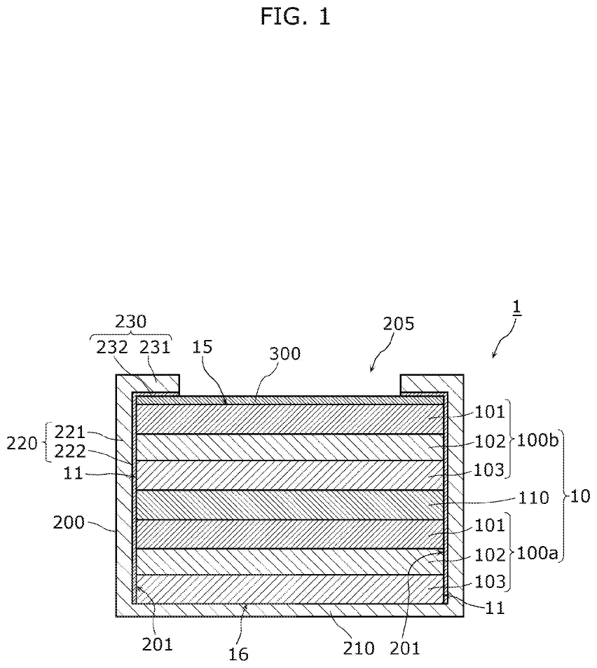

FIG. 1 is a cross-sectional view of battery 1 according to an embodiment. As shown in FIG. 1, battery 1 includes power generator including power generating element 100a, power generating element 100b, and electron conductive layer 110, housing 200 that houses power generator 10, and current collector 300. Battery 1 is, for example, an all-solid battery. In addition, battery 1 is, for example, a lithium ion secondary battery.

Power generator 10 is a stack in which each layer of power generating element 100a and power generating element 100b and electron conductive layer 110 are stacked. The shape of power generator 10 is, for example, a flat columnar body, such as a square column such as a rectangular parallelepiped, a polygonal column other than a square column, a cylinder, or an elliptical column. For that reason, the shape of power generator 10 in a plan view is, for example, a quadrangle such as a rectangle or a square, a polygon other than a quadrangle such as a hexagon or an octagon, a circle, an ellipse or the like. In cross-sectional views such as FIG. 1, the thickness of each layer is exaggerated in order to make the layered structure of power generator 10 easier to understand. In addition, the relationship between the thicknesses of each layer and housing 200 is not limited to the example shown in FIG. 1.

Power generator 10 includes side surface 11, main surface 15, and main surface 16. Side surface 11 is a surface that connects the outer periphery of main surface 15 and the outer periphery of main surface 16. Side surface 11 is, for example, a surface parallel to the stacking direction of power generator 10. Main surface 15 and main surface 16 are each a surface perpendicular to the thickness direction of each layer. Main surface 15 and main surface 16 are opposite to each other and parallel to each other. Main surface 15 is the uppermost surface of power generator 10. Main surface 16 is the lowermost surface of power generator 10.

Power generator 10 is formed, for example, by pressing powder of the material of power generator 10 within housing 200, and is held within housing 200. For example, all of side surfaces 11 and main surface 16 of power generator 10 are covered by housing 200 and are in contact with the inner surface of housing 200.

Power generator 10 includes a plurality of power generating elements, in the example shown in FIG. 1, two power generating elements 100a and 100b. Power generating element 100a and power generating element 100b are, for example, batteries with a minimum configuration, and are also referred to as unit cells. Power generating element 100a and power generating element 100b are stacked and electrically connected in series via electron conductive layer 110. In the example shown in FIG. 1, power generating element 100a is the power generating element located at the bottom of power generator 10, and power generating element 100b is the power generating element located at the top of power generator 10. It should be noted that in the example shown in FIG. 1, the number of power generating elements included in power generator 10 is two, but the number is not limited thereto. For example, power generator may include three or more power generating elements. In this case, adjacent power generating elements are stacked with electron conductive layer 110 interposed therebetween.

Power generating element 100a and power generating element 100b are stacked bodies each including electrode layer 101, counter electrode layer 103 disposed to face electrode layer 101, and solid electrolyte layer 102 located between electrode layer 101 and counter electrode layer 103. Electrode layer 101 and counter electrode layer 103 contain an active material and are also referred to as an electrode active material layer and a counter electrode active material layer, respectively. In each of power generating element 100a and power generating element 100b, electrode layer 101, solid electrolyte layer 102, and counter electrode layer 103 are stacked in stated order along the normal direction of the main surface of each layer. In addition, in power generator 10, power generating element 100a and power generating element 100b are stacked with electron conductive layer 110 interposed therebetween so that the layers included in power generating element 100a and power generating element 100b are arranged in the same order.

It should be noted that electrode layer 101 is one of the positive electrode layer and the negative electrode layer of the power generating element. Counter electrode layer 103 is the other of the positive electrode layer and the negative electrode layer of the power generating element. Hereinafter, the case where electrode layer 101 is a negative electrode layer and counter electrode layer 103 is a positive electrode layer will be described as an example.

Electrode layer 101 includes, for example, an electrode material. The electrode material includes a negative electrode active material. The electrode material is, for example, powder. “is powder” can also be said to include an aggregate of a plurality of particles. Specifically, the electrode material is, for example, a green compact formed by compacting powder.

The shape of the particles included in the electrode material is, for example, acicular, spherical, ellipsoidal, scaly, or the like, but is not particularly limited. In addition, the shape of the particles is the same for powders of other materials described later.

As the negative electrode active material included in the electrode material of electrode layer 101, various materials that can extract and insert ions such as lithium (Li) or magnesium (Mg) can be used. As the negative electrode active material, for example, graphite, metallic lithium, lithium compounds, and the like can be used. As the lithium compounds, for example, lithium alloys such as LiAl, LiZn, Li₃Bi, Li₃ Cd, Li₃Sb, Li₄Si, Li_{4.4}Pb, Li_{4.4}Sn, Li_{0.17} C, and LiC₆, oxides of lithium and transition metal elements such as lithium titanate (Li₄Ti₅O₁₂), and metal oxides such as zinc oxide (ZnO) and silicon oxide (SiOₓ) can be used.

In addition, the electrode material of electrode layer 101 may contain, for example, a solid electrolyte such as an inorganic solid electrolyte. As the inorganic solid electrolyte, for example, a sulfide solid electrolyte, an oxide solid electrolyte, or the like can be used. As the sulfide solid electrolyte, for example, a mixture of lithium sulfide (Li₂S) and diphosphorus pentasulfide (P₂S₅) can be used. In addition, the electrode material of electrode layer 101 may contain a conductive agent such as acetylene black and the like.

The thickness of electrode layer 101 is, for example, at least 5 μm and at most 2000 μm.

Counter electrode layer 103 includes, for example, a counter electrode material. The counter electrode material is a material included in the counter electrode of the electrode material. The counter electrode material includes a positive electrode active material. The counter electrode material is, for example, powder. Specifically, the counter electrode material is, for example, a green compact formed by compacting powder.

As the material of the positive electrode active material included in the counter electrode material of counter electrode layer 103, various materials that can extract and insert ions such as Li or Mg can be used. As the positive electrode active material, for example, the positive electrode active materials such as lithium cobaltate composite oxide (LCO), lithium nickelate composite oxide (LNO), lithium manganate composite oxide (LMO), lithium-manganese-nickel composite oxide (LMNO), lithium-manganese-cobalt composite oxide (LMCO), lithium-nickel-cobalt composite oxide (LNCO), and lithium-nickel-manganese-cobalt composite oxide (LNMCO) can be used. The surface of the positive electrode active material may be coated with a solid electrolyte.

In addition, the counter electrode material of counter electrode layer 103 may contain at least one of a solid electrolyte such as an inorganic solid electrolyte or a conductive agent such as acetylene black, for example, similar to the electrode material mentioned above.

The thickness of counter electrode layer 103 is, for example, at least 5 μm and at most 2000 μm.

Solid electrolyte layer 102 is in contact with each of electrode layer 101 and counter electrode layer 103. Solid electrolyte layer 102 includes, for example, an electrolyte material. The electrolyte material includes a solid electrolyte. The solid electrolyte has, for example, lithium ion conductivity. The electrolyte material is, for example, powder. Specifically, the electrolyte material is, for example, a green compact formed by compacting powder.

As the solid electrolyte contained in the electrolyte material of solid electrolyte layer 102, for example, a solid electrolyte such as an inorganic solid electrolyte can be used. As the inorganic solid electrolyte, a sulfide solid electrolyte or an oxide solid electrolyte can be used. As the sulfide solid electrolyte, for example, a mixture of Li₂S and P₂S₅ can be used.

The thickness of solid electrolyte layer 102 is, for example, at least 5 μm and at most 500 μm, and may be at least 5 μm and at most 100 μm.

For example, each of power generating element 100a and power generating element 100b does not contain a binder. Specifically, electrode layer 101, counter electrode layer 103, and solid electrolyte layer 102 of power generating element 100a and power generating element 100b each do not contain a binder. Accordingly, since power generating element 100a and power generating element 100b do not contain a binder that does not contribute to the charge/discharge reaction, the ratio of the active material and solid electrolyte in power generating element 100a and power generating element 100b increases, and the energy density of battery 1 can be increased.

The binder is an adhesive material that plays a role in bonding the materials of each layer and adjacent layers together. For example, resin, elastomer, rubber, or the like is used as the binder. It should be noted that there may be a layer containing a binder among electrode layer 101, counter electrode layer 103, and solid electrolyte layer 102 of each of power generating element 100a and power generating element 100b. In addition, in this specification, “not contain a binder” means that it does not substantially contain a binder, and specifically, it means the case where it does not contain a binder at all, and the case where it unavoidably contains a binder of 100 ppm or less as an impurity or the like.

In addition, power generating element 100a and power generating element 100b each do not contain a solvent such as an organic solvent or the like. Specifically, electrode layer 101, counter electrode layer 103, and solid electrolyte layer 102 of each of power generating element 100a and power generating element 100b do not contain a solvent. This suppresses deterioration of the materials of each layer due to the solvent, so that battery performance can be improved. It should be noted that among electrode layer 101, counter electrode layer 103, and solid electrolyte layer 102 of each of power generating element 100a and power generating element 100b, there may be a layer containing a solvent. In addition, in this specification, “not contain a solvent” means that it does not substantially contain a solvent, and specifically, it means the case where it does not contain a solvent at all, and the case where it unavoidably contains a solvent of 50 ppm or less as an impurity or the like.

Electrode layer 101, counter electrode layer 103, and solid electrolyte layer 102 are maintained in a parallel plate shape, for example.

In addition, in this embodiment, the side surface of electrode layer 101, the side surface of solid electrolyte layer 102, and the side surface of counter electrode layer 103 match when viewed along the stacking direction. More specifically, in power generating element 100a and power generating element 100b, the shape and size of each of electrode layer 101, solid electrolyte layer 102, and counter electrode layer 103 are the same when viewed along the stacking direction, and their respective contours match.

Power generating element 100a, power generating element 100b, and electron conductive layer 110 are stacked within housing 200. In addition, the side surface of each of power generating element 100a and 100b and the side surface of electron conductive layer 110 match with each other when viewed along the stacking direction, and are included in side surface 11 of power generator 10.

Electron conductive layer 110 is located between power generating element 100a and power generating element 100b, and is in contact with each of power generating element 100a and power generating element 100b. Specifically, one main surface of electron conductive layer 110 is in contact with electrode layer 101 of power generating element 100a and is electrically connected to that electrode layer 101. In addition, the other main surface of electron conductive layer 110 is in contact with counter electrode layer 103 of power generating element 100b and is electrically connected to that counter electrode layer 103. Accordingly, power generating element 100a and power generating element 100b are electrically connected in series via electron conductive layer 110. It should be noted that an electrically conductive connection layer may be disposed between electron conductive layer 110 and at least one of power generating element 100a or and power generating element 100b.

Electron conductive layer 110 has, for example, electron conductivity but no ionic conductivity. Electron conductive layer 110 includes an electron conductive material having electron conductivity. Electron conductive layer 110 consists, for example, only of an electron conductive material. Accordingly, electron conductive layer 110 does not contain any material that inhibits electron conduction, and stable battery characteristics can be obtained.

The electron conductive material included in electron conductive layer 110 is, for example, powder. Specifically, the electron conductive material included in electron conductive layer 110 is, for example, a green compact formed by compacting powder. Each of the plurality of particles included in the powder of the electron conductive material has electron conductivity. For example, metals such as stainless steel, aluminum, copper, and nickel, or conductive carbon can be used as the electron conductive material. In addition, the electron conductive material may contain multiple types of conductive substances.

The thickness of electron conductive layer 110 is, for example, at least 15 μm and at most 300 μm. When the thickness of electron conductive layer 110 is at least 15 μm, contact between power generating element 100a and power generating element 100b is suppressed, the occurrence of spontaneous discharge is suppressed, and battery 1 with higher energy density can be realized. In addition, when the thickness of electron conductive layer 110 is at most 300 μm, the volume occupied by electron conductive layer 110 in housing 200 can be reduced, and battery 1 with higher energy density can be realized.

It should be noted that although details will be described later, at least one of a grain boundary or a void may be formed in electron conductive layer 110.

Housing 200 is a box-shaped container that houses power generator 10 and current collector 300, and serves to protect power generator 10. In addition, in the present embodiment, housing 200 also functions as a current extractor of power generator 10.

Housing 200 includes, for example, bottom plate portion 210, side wall portion 220, and bent portion 230. Bottom plate 210, side wall portion 220, and bent portion 230 are names given to respective portions formed by processing one member, for example. Housing 200 may be formed by connecting bottom plate portion 210, side wall portion 220, and bent portion 230, each of which includes another member. In addition, opening 205 is formed in the center of the upper part of housing 200. Opening 205 exposes current collector 300. Specifically, opening 205 exposes the surface of current collector 300 on the side opposite to the side of power generating element 100b. It should be noted that housing 200 does not need to have bent portion 230.

Bottom plate portion 210 is plate-shaped and included in the bottom of box-shaped housing 200. Bottom plate portion 210 covers main surface 16 of power generator 10 and is in contact with main surface 16. Bottom plate portion 210 has, for example, electron conductivity. In the present embodiment, bottom plate portion 210 is an example of a conductor. Bottom plate portion 210 is electrically connected to power generating element 100a. Specifically, bottom plate portion 210 faces electron conductive layer 110 with power generating element 100a interposed therebetween. Bottom plate portion 210 is in contact with counter electrode layer 103 of power generating element 100a and is electrically connected to counter electrode layer 103. For that reason, in the present embodiment, bottom plate portion 210 can be used for extracting current from the positive electrode of power generator 10.

Side wall portion 220 stands upward from the outer peripheral portion of bottom plate portion 210 along the stacking direction, and is included in a side wall of box-shaped housing 200. In this embodiment, the surface of side wall portion 220 on the side of power generator 10 is inner side surface 201 of housing 200. Side wall portion 220 surrounds power generator 10 from the side when viewed along the stacking direction.

Side wall portion 220 includes conductor 221 and insulator 222. Conductor 221 is disposed to face side surface 11 with insulator 222 interposed therebetween. Conductor 221 is, for example, plate-shaped. Conductor 221 is not in contact with power generator 10 and current collector 300. Insulator 222 is an insulating layer that covers the surface of conductor 221 on the side of power generator 10. Insulator 222 is in contact with side surface 11 of power generator 10. More specifically, the surface of insulator 222 on the side of power generator 10 is included in inner side surface 201 that is a part of the inner surface of housing 200. Power generating element 100a, power generating element 100b, electron conductive layer 110, and current collector 300 are each in contact with inner side surface 201. All of the side surfaces of power generating element 100a, power generating element 100b, electron conductive layer 110, and current collector 300 are in contact with inner side surface 201, for example.

Bent portion 230 extends inward from the upper end of side wall portion 220 (that is, the end opposite to the side of bottom plate portion 210) so that the upper portion of side wall portion 220 is bent. Bent portion 230 covers a part of main surface 15 of power generator 10. Specifically, bent portion 230 covers main surface 15 with current collector 300 interposed therebetween. In addition, bent portion 230 surrounds opening 205.

Bent portion 230 includes conductor 231 and insulator 232. Conductor 231 is disposed to face main surface 15 with insulator 232 interposed therebetween. Conductor 231 is not in contact with power generator 10 and current collector 300. Insulator 232 is an insulating layer that covers the surface of conductor 231 on the side of power generator 10. Insulator 232 faces main surface 15 with current collector 300 interposed therebetween and is in contact with current collector 300.

Housing 200 is, for example, a composite member including an electron conductive material and an electrically insulating material.

Bottom plate portion 210, conductor 221, and conductor 231 are integrally formed as a box-shaped member including an electron conductive material, for example. As the electron conductive material included in bottom plate portion 210, conductor 221, and conductor 231, for example, metals such as stainless steel, aluminum, copper, and nickel are used.

Insulator 222 and insulator 232 are integrally formed as a thin film including an electrically insulating material such as resin, for example. Insulator 222 and insulator 232 are formed by applying resin to the inner surfaces of conductor 221 and conductor 231 in a box-shaped member including bottom plate portion 210, conductor 221, and conductor 231, for example. In addition, the electrically insulating material may be an inorganic material such as ceramic.

Current collector 300 is disposed within housing 200 on the side opposite to the side of electron conductive layer 110 of power generating element 100b, and is in contact with main surface 15 of power generator 10. Specifically, current collector 300 is in contact with electrode layer 101 of power generating element 100b and is electrically connected to that electrode layer 101. For that reason, in the present embodiment, current collector 300 can be used to extract current from the negative electrode of power generator 10. It should be noted that an electrically conductive connection layer may be disposed between current collector 300 and power generating element 100b.

Current collector 300 is, for example, an electrically conductive foil-like, plate-like, or mesh-like member that has electron conductivity. As the material included in current collector 300, metals such as stainless steel, aluminum, copper, and nickel can be used, for example. The metal used for current collector 300 may be the same as or different from the metal used for bottom plate portion 210.

### [Manufacturing Method]

Next, a method for manufacturing battery 1 according to the present embodiment will be described. It should be noted that the method for manufacturing battery 1 described below is an example, and the method for manufacturing battery 1 is not limited to the following manufacturing method.

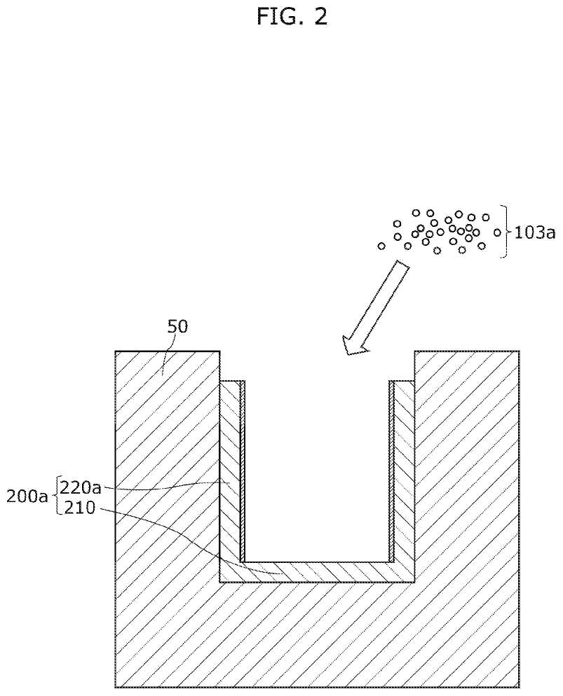

FIG. 2 to FIG. 5 are diagrams for explaining the method for manufacturing battery 1 according to the present embodiment.

In the method for manufacturing battery 1, first, as shown in FIG. 2, housing 200a is set in press mold 50 provided in a press device. For example, press mold 50 is provided with a recessed portion having the same size as housing 200a, and housing 200a is set in the recessed portion. Housing 200a is a housing before bent portion 230 is formed in housing 200 mentioned above. Housing 200a is, for example, a box-shaped container that includes bottom plate portion 210 and side wall portion 220a that stands upward from the outer periphery of bottom plate portion 210, and has the top of housing 200a open.

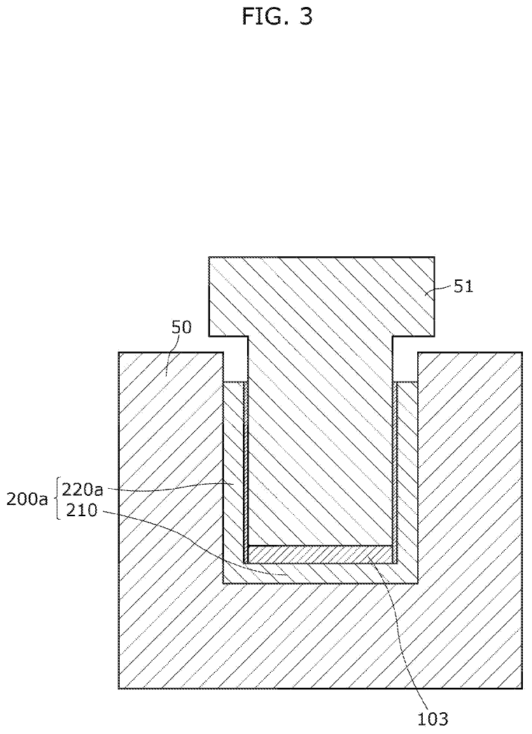

Next, materials for forming power generating element 100a are put into housing 200a. That is, a counter electrode material, an electrolyte material, and an electrode material for forming the respective layers of power generating element 100a are put into housing 200a in stated order. Specifically, as shown in FIG. 2, first, counter electrode material 103a for forming counter electrode layer 103 of power generating element 100a included in the lowermost layer of power generator 10 is put into housing 200a. Counter electrode material 103a is a material in powder form. Then, as shown in FIG. 3, counter electrode layer 103 is formed by temporarily pressing counter electrode material 103a put into housing 200a using columnar press pin 51 provided in the press device. By putting counter electrode material 103a in powder form into housing 200a and pressing it in this manner, counter electrode layer 103 in which counter electrode material 103a is compacted into a layer can be formed. In addition, by performing the temporary pressing, it is possible to suppress mixing of the material to be put into next and counter electrode material 103a. The pressure of the temporary press is not particularly limited and is set depending on the material to be pressed, and is, for example, at least 20 MPa and at most 100 MPa.

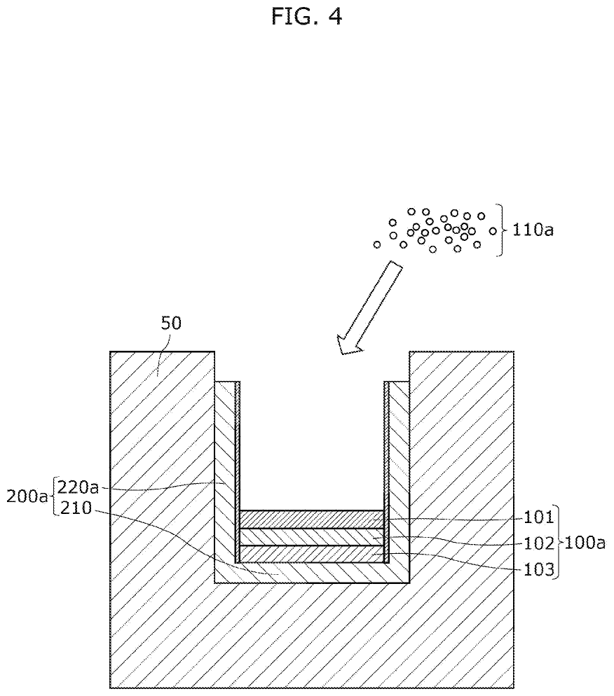

Similar to counter electrode layer 103, solid electrolyte layer 102 is formed by putting an electrolyte material in powder form for forming solid electrolyte layer 102 of power generating element 100a into housing 200a in which counter electrode layer 103 has been formed and temporarily pressing the electrolyte material that has been put into housing 200a. Next, electrode layer 101 is formed by putting an electrode material in powder form for forming electrode layer 101 of power generating element 100a into housing 200a in which counter electrode layer 103 and solid electrolyte layer 102 have been formed and temporarily pressing the electrode material that has been put into housing 200a. Accordingly, as shown in FIG. 4, power generating element 100a, in which counter electrode layer 103, solid electrolyte layer 102, and electrode layer 101 are stacked in stated order from the bottom on bottom plate portion 210 of housing 200a, is formed inside housing 200a.

Next, as shown in FIG. 4, electron conductive material 110a for forming electron conductive layer 110 is put into housing 200a in which power generating element 100a has been formed. Electron conductive material 110a is a material in powder form. Then, electron conductive layer 110 is formed by temporarily pressing electron conductive material 110a that has been put into housing 200a. In this way, by putting electron conductive material 110a in powder form containing voids into housing 200a, electron conductive material 110a is spread out within housing 200a, and electron conductive layer 110 that separates power generating element 100a and power generating element 100b can be formed.

Next, materials for forming power generating element 100b are put into housing 200a in which power generating element 100a and electron conductive layer 110 have been formed. That is, a counter electrode material, an electrolyte material, and an electrode material for forming the respective layers of power generating element 100b are put into housing 200a in stated order. For example, power generating element 100b is formed on electron conductive layer 110 in housing 200 by repeating the input of materials and temporary pressing in the same manner as power generating element 100a. In this way, through the step of putting the material for forming power generating element 100a, the material for forming electron conductive layer 110, and the material for forming power generating element 100b into housing 200a in stated order, a stack is formed in which power generating element 100a, electron conductive layer 110, and power generating element 100b are stacked in stated order from the bottom. In addition, the material input in this step is a material in powder form that does not contain a solvent.

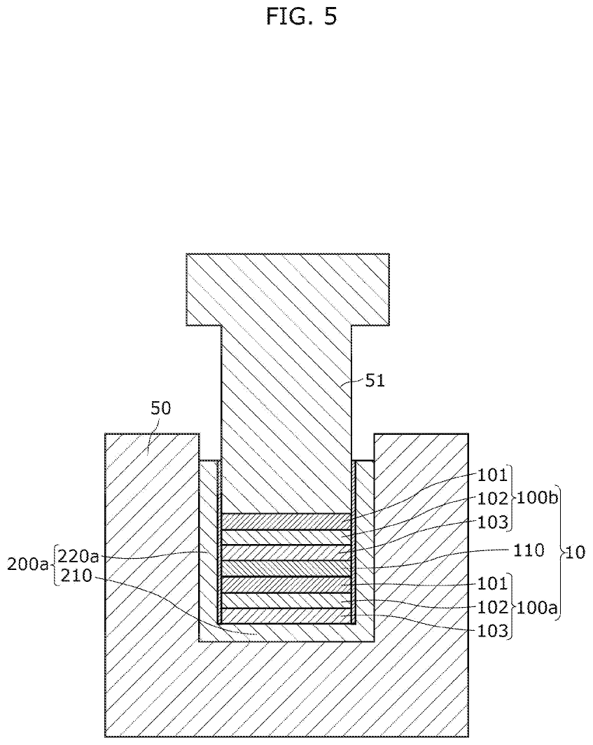

Then, as shown in FIG. 5, power generating element 100a, electron conductive layer 110, and power generating element 100b, which have been formed from the respective materials put into housing 200a, are subjected to a main press at once. Accordingly, power generator 10 is formed. The pressure of the main press is not particularly limited and is set depending on the material to be pressed, and is, for example, at least 200 MPa and at most 1000 MPa. In this way, by going through the step of pressing each material put into housing 200a, power generating element 100a, power generating element 100b, and electron conductive layer 110 are formed in close contact with the inner side surface of side wall portion 220a of housing 200a. It should be noted that the main press may be performed each time the material of each layer is input instead of the above-mentioned temporary press. That is, the main press may be performed during the step of putting the material into housing 200a.

Finally, bent portion 230 is formed by disposing current collector 300 on power generating element 100b and bending side wall portion 220a protruding above current collector 300 by caulking or the like within housing 200a. Accordingly, battery 1 shown in FIG. 1 is obtained.

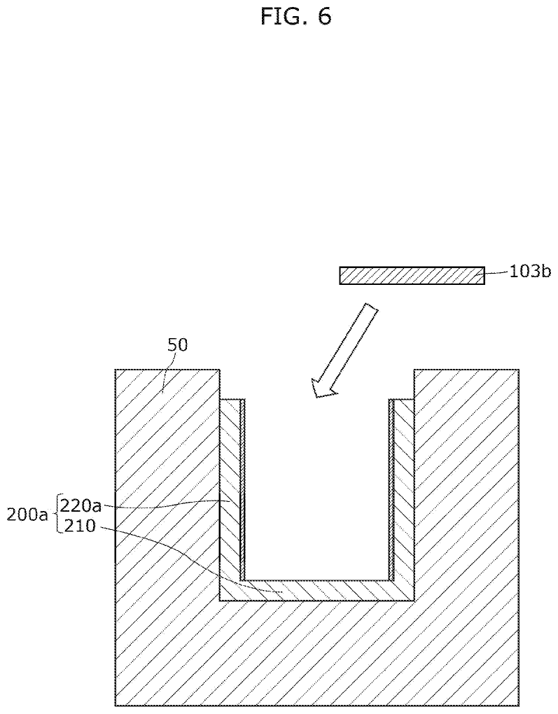

It should be noted that in the above-mentioned manufacturing method, a material in powder form is put into housing 200a as a material for forming power generating element 100a and power generating element 100b, but the present disclosure is not limited thereto. FIG. 6 is a diagram for explaining a variation of the method for manufacturing battery 1 according to the present embodiment.

The material for forming power generating element 100a and power generating element 100b that is put into housing 200a may be in pellet form. For example, battery 1 is manufactured by the above-mentioned manufacturing method, except that the materials for forming power generating element 100a and power generating element 100b are changed from the materials in powder form to the materials in pellet form. Specifically, as shown in FIG. 6, first, counter electrode material 103b in pellet form for forming counter electrode layer 103 of power generating element 100a is put into housing 200a. When inputting counter electrode material 103b in pellet form, it is not necessary to perform a temporary press as mentioned above, for example.

Counter electrode material 103b in pellet form is formed, for example, by placing the counter electrode material in powder form into a mold or the like different from housing 200a and pressing and compacting it. That is, counter electrode material 103b in pellet form is, for example, a green compact. The pressure of the press at this time is, for example, the pressure of the temporary press or main press mentioned above. Alternatively, counter electrode material 103b in pellet form may be formed by pressing a counter electrode material in powder form using a flat plate press device or the like to form a counter electrode material in the form of a flat plate, and punching out the counter electrode material in the form of a flat plate to match the shape of the internal space of housing 200a. It should be noted that depending on the thickness of counter electrode material 103b, counter electrode material 103b becomes a material in pellet form with a fairly flat film shape, but in this specification, such a material as a film shape is also included in a material in pellet form. In this specification, a material in pellet form means a material that is integrated so that the material is not easily separated, such as a green compact.

For each layer of power generating element 100a and power generating element 100b other than counter electrode layer 103 of power generating element 100a as well, power generating element 100a and power generating element 100b are formed in housing 200a by putting materials in pellet form into housing 200a as a counter electrode material, an electrolyte material, or an electrode material for forming each layer. The material in pellet form can be formed in the same manner as counter electrode material 103b. Alternatively, materials in pellet form in which a counter electrode material, an electrolyte material, and an electrode material are stacked may be put into housing 200a.

Through such steps, a stack of power generating element 100a, electron conductive layer 110, and power generating element 100b as shown in FIG. 5 is formed in housing 200a. Then, in the same manner as in the above-mentioned method, battery 1 shown in FIG. 1 is obtained by disposing current collector 300 and forming bent portion 230.

In this way, by putting the material in pellet form into housing 200a as a material for forming power generating element 100a and power generating element 100b, battery 1 can be manufactured through a simpler manufacturing process. In addition, the materials in the respective layers of power generating element 100a and power generating element 100b are difficult to mix, and the battery characteristics of battery 1 can be improved.

### [Effects, etc.]

As described above, in battery 1, each side surface of the stacked power generating element 100a and power generating element 100b is in contact with inner side surface 201, which is the inner surface of housing 200. Accordingly, the inside of housing 200 is filled with power generating element 100a and power generating element 100b, so that the internal space of housing 200 can be effectively utilized. For example, the internal space of housing 200 can be utilized to the maximum. Therefore, battery 1 with high energy density can be realized. In addition, since the side surfaces of power generating element 100a and power generating element 100b are in close contact with side wall portion 220 of housing 200, they are strongly restrained in the vertical direction of side wall portion 220. This suppresses deterioration in voltage and capacity caused by repeated expansion and contraction of the active material during the charging and discharging process. In addition, in battery 1, power generating element 100a and power generating element 100b are electrically connected in series, and battery 1 with high voltage and high energy density can be realized.

In addition, in battery 1, the electron conductive material included in electron conductive layer 110 is powder. Accordingly, the powder of the electron conductive material spreads between power generating element 100a and power generating element 100b in housing 200, and electron conductive layer 110 can be brought into close contact with inner side surface 201 of housing 200. For that reason, electron conductive layer 110 exists at any position between power generating element 100a and power generating element 100b, and a short circuit (specifically, an ion conductive short circuit) between power generating element 100a and power generating element 100b can be suppressed. In particular, short circuits at the ends of power generating element 100a and power generating element 100b, where short circuits tend to occur, can be suppressed. In addition, since spontaneous discharge is likely to occur when power generating element 100a and power generating element 100b come into contact with each other, the capacity of battery 1 can be increased by suppressing the contact between power generating element 100a and power generating element 100b.

Here, the point that short circuit between power generating element 100a and power generating element 100b is suppressed will be explained using the results of manufacturing and charging/discharging a battery.

First, battery 1 manufactured by the manufacturing method mentioned above using powder for electron conductive layer 110 was charged and discharged. Specifically, manufactured battery 1 was charged under conditions of a final voltage of 5.5V and a current rate of 0.05 C. Then, charged battery 1 was discharged under conditions of a final voltage of 2.0V and a current rate of 0.05 C. As a result, the average discharge voltage during discharge was 4.2V. The average discharge voltage is the time average of the voltage during discharge. Next, when charging and discharging battery 1 using metal foil for electron conductive layer 110, the average discharge voltage was 3.4V, and the discharge capacity was also lower than the case of electron conductive layer 110 using powder mentioned above. In addition, since the average discharge voltage when discharging was performed in a battery including one power generating element was 2.1V, it can be seen that battery 1 manufactured using powder for electron conductive layer 110 has power generating element 100a and power generating element 100b electrically connected in series without short circuit.

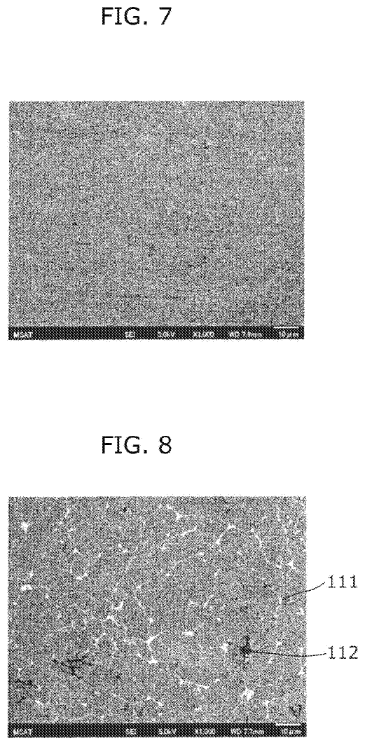

FIG. 7 is a scanning electron microscope image of a cut surface of electron conductive layer 110 using metal foil. FIG. 8 is a scanning electron microscope image of a cut surface of electron conductive layer 110 using powder. As shown in FIG. 7, electron conductive layer 110 using metal foil has a continuous composition, and no voids or grain boundaries are observed. On the other hand, as shown in FIG. 8, electron conductive layer 110 using powder has powder grain boundaries 111 (white areas in the scanning electron microscope image) and voids 112 (black areas in the scanning electron microscope image). In this way, since grain boundaries 111 and voids 112 are formed in electron conductive layer 110, the electron conductive material of electron conductive layer 110 can easily move, and the electron conductive material is more easily spread between power generating element 100a and power generating element 100b in housing 200. Therefore, electron conductive layer 110 can be in close contact with inner side surface 201 of housing 200, and can suppress contact between power generating element 100a and power generating element 100b. In addition, since voids 112 are formed in electron conductive layer 110, the stress on electron conductive layer 110 can be alleviated by voids 112, so that damage to electron conductive layer 110 can be suppressed.

### OTHER EMBODIMENTS

Although a battery and a method for manufacturing the battery according to the present disclosure have been described above based on the embodiment, the present disclosure is not limited to the embodiment. Forms obtained by applying various modifications to the embodiment conceived by a person skilled in the art or forms realized by combining some components in the embodiment without departing from the spirit of the present disclosure are also included within the scope of this disclosure.

For example, in the embodiment described above, power generating element 100a and power generating element 100b are electrically connected in series, but the present disclosure is not limited thereto. Power generating element 100a and power generating element 100b may be electrically connected in parallel. Accordingly, the capacity of battery 1 can be increased. In addition, in this case, for example, a housing configured to have a conductor electrically connected to electron conductive layer 110 between power generating element 100a and power generating element 100b is used for housing 200.

In addition, for example, in the embodiment described above, an example in which an electron conductive material in powder form is used for electron conductive layer 110 is mainly described, but the present disclosure is not limited thereto. Metal foil may be used for electron conductive layer 110. For example, by using a metal foil with a larger area than the main surfaces of power generating element 100a and power generating element 100b, adjusting the pressure in the temporary press and main press, etc., power generating element 100a and power generating element 100b can be configured so that they do not contact each other, thereby suppressing a short circuit between power generating element 100a and power generating element 100b. In addition, as the electron conductive material for forming electron conductive layer 110, porous metal or porous conductive resin may be used.

In addition, for example, in the embodiment described above, each of the side surfaces of power generating element 100a and power generating element 100b is in contact with inner side surface 201 of housing 200, but the present disclosure is not limited thereto. A side surface of only one of power generating element 100a and power generating element 100b may be in contact with inner side surface 201 of housing 200.

In addition, in the embodiment described above, side wall portion 220 and bent portion 230 of housing 200 each include a conductor and an insulator, but the present disclosure is not limited thereto. At least one of side wall portion 220 or bent portion 230 may consist only of an insulator. In addition, in housing 200, when bottom plate portion 210 and bent portion 230 are insulated, bent portion 230 may consists only of conductor 231. In this case, battery 1 does not need to be provided with current collector 300, and conductor 231 comes into contact with main surface 15 and functions as a current collector. In addition, in this case, conductor 231 of bent portion 230 may cover main surface 15 entirely.

In addition, in the embodiment described above, bottom plate portion 210 includes an electron conductive material, but the present disclosure is not limited thereto. A part of bottom plate portion 210 may include an electrically insulating material. That is, bottom plate portion 210 may include a conductor and an insulator.

In addition, for example, in the embodiment described above, housing 200 includes a composite member including an electronically conductive material and an electrically insulating material, but the present disclosure is not limited thereto. Housing 200 may entirely include electrically insulating material. In this case, for example, an opening for extracting current from power generator 10 is formed in housing 200.

In addition, for example, in the embodiment described above, an example has been described in which the ions conducted in battery 1 are lithium ions, but the present disclosure is not limited thereto. Ions conducted in battery 1 may be ions other than lithium ions, such as sodium ions, magnesium ions, potassium ions, calcium ions, or copper ions.

In addition, the embodiment described above can be modified, replaced, added, omitted, etc. in various ways within the scope of the claims or their equivalents.

### INDUSTRIAL APPLICABILITY

The battery according to the present disclosure can be used, for example, as a secondary battery such as an all-solid-state battery used in various electronic devices or automobiles.

1. A battery comprising:
a housing;
a first power generating element;
a second power generating element; and
an electron conductive layer located between the first power generating element and the second power generating element,
wherein the first power generating element and the second power generating element are each a stack including an electrode layer, a counter electrode layer, and a solid electrolyte layer located between the electrode layer and the counter electrode layer,
the first power generating element, the second power generating element, and the electron conductive layer are stacked within the housing, and
a side surface of at least one of the first power generating element or the second power generating element is in contact with an inner surface of the housing.

2. The battery according to claim 1,
wherein the electron conductive layer includes an electron conductive material, and
the electron conductive material is powder.

3. The battery according to claim 2,
wherein the electron conductive layer consists only of the electron conductive material.

4. The battery according to claim 2,
wherein the electron conductive layer has a grain boundary of the powder of the electron conductive material.

5. The battery according to claim 2,
wherein the first power generating element and the second power generating element are electrically connected in series.

6. The battery according to claim 1,
wherein at least one of the electrode layer, the counter electrode layer, or the solid electrolyte layer in at least one of the first power generating element or the second power generating element does not contain a binder.

7. The battery according to claim 6,
wherein at least one of the first power generating element or the second power generating element does not contain the binder.

8. The battery according to claim 1,
wherein the electron conductive layer has a thickness of at least 15 μm and at most 300 μm.

9. The battery according to claim 1,
wherein the electron conductive layer includes a void.

10. The battery according to claim 1,
wherein the housing includes an insulator in contact with the side surface and a conductor electrically connected to the first power generating element.

11. The battery according to claim 10, further comprising:
a current collector disposed within the housing and on a side of the second power generating element opposite a side on which the electron conductive layer is disposed,
wherein the conductor is a bottom plate portion of the housing that faces the electron conductive layer with the first power generating element interposed between the bottom plate portion and the electron conductive layer, and
the housing includes an opening that exposes the current collector.

12. The battery according to claim 1,
wherein each of the first power generating element, the second power generating element, and the electron conductive layer is in contact with the inner surface.

13. A method for manufacturing a battery including a first power generating element and a second power generating element, each of which is a stack including an electrode layer, a counter electrode layer, and a solid electrolyte layer located between the electrode layer and the counter electrode layer, the method comprising:
putting a material for forming the first power generating element, a material for forming an electron conductive layer, and a material for forming the second power generating element into a housing in stated order; and
pressing each material put into the housing.

14. The method for manufacturing the battery according to claim 13,
wherein the putting includes putting a material for forming the electron conductive layer in powder form into the housing.

15. The method for manufacturing the battery according to claim 13,
wherein the putting includes putting a material for forming the first power generating element in powder form and a material for forming the second power generating element in powder form into the housing.

16. The method for manufacturing the battery according to claim 13,
wherein the putting includes putting a material for forming the first power generating element in pellet form and a material for forming the second power generating element in pellet form into the housing.
